(19) United States
(12) Patent Application Publication
(10) Pub. No.: US 2026/0302264 A1
(43) Pub. Date: Oct. 1, 2026

(54) FUEL CELL ELECTRODE AND FUEL CELL COMPRISING THE SAME

(71) Applicant: KOREA INSTITUTE OF SCIENCE AND TECHNOLOGY, Seoul (KR)

(72) Inventors: Kyung Joong YOON, Seoul (KR); Sun-Young Park, Seoul (KR); Jinhong Park, Seoul (KR); Ji-Won Son, Seoul (KR); Sungeun Yang, Seoul (KR)

(21) Appl. No.: 19/456,766

(22) Filed: Jan. 22, 2026

(30) Foreign Application Priority Data
Mar. 26, 2025 (KR) 10-2025-0038822

(51) Int. Cl. H01M 4/86; H01M 8/12

(52) U.S. Cl. CPC H01M 4/8626; H01M 8/12; H01M 2004/8689; H01M 2008/1293

(57) ABSTRACT

One embodiment of the present disclosure relates to an electrode of a fuel cell and a fuel cell including the same. An electrode of a fuel cell according to an embodiment of the present disclosure includes a substrate and an oxide film formed on one or both surfaces of the substrate, wherein the oxide film includes a spinel including at least one of Co, Ni, Cu, Mn, Fe, and Cr.

### CROSS-REFERENCE TO RELATED APPLICATION

This application claims priority to and the benefit of Korean Patent Application No. 10-2025-0038822 filed with the Korean Intellectual Property Office on Mar. 26, 2025, the entire contents of which are incorporated herein by reference.

### BACKGROUND OF THE INVENTION

### (a) Field of the Invention

One embodiment of the present disclosure relates to an electrode of a fuel cell and a fuel cell including the same. Specifically, the present disclosure relates to an electrode of a fuel cell capable of protecting the electrode from Cr gas by forming an oxide film on a surface of a substrate, and a fuel cell including the same.

### (b) Description of the Related Art

A solid oxide fuel cell (SOFC) and a high-temperature water electrolysis cell (SOEC) operate at high temperatures.

A high-temperature degradation is a biggest problem in the commercialization of the SOFC and SOEC, and among the various high-temperature degradation phenomena, a Cr poisoning is known to be a very chronic and difficult problem to be solved.

The stack and system of the SOFC and SOEC include various metal parts including metal separators, and a high-temperature stainless steel with an excellent oxidation resistance at high temperatures is generally used.

The high-temperature stainless steel includes a large amount of Cr to form a high-temperature oxidation-resistant film.

In a high-temperature oxidizing atmosphere, Cr in the stainless steel volatilizes into a gas.

The volatilized Cr moves into the cell and is deposited on the surface of the electrode, forming an inactive/non-conductive compound that deteriorates the performance of the electrode.

This volatilization of Cr and the electrode poisoning are inevitable phenomena in the SOFC and the SOEC, and much research has been conducted to suppress them.

A method of depositing a protective coating on the metal surface, such as the metal separator, has been proposed; however, with the exception of some components such as the separator, the size and shape of many parts make it difficult to apply the protective coating.

In addition, electrode materials with high durability against the Cr poisoning have been proposed, but the performance of the resistance poisoning material itself is significantly low, making it difficult to apply it to the actual cell.

Accordingly, in order to secure the durability of the SOFC, SOEC stacks and systems, a technology is needed to protect the electrode from the Cr gas flowing in from outside.

### SUMMARY OF THE INVENTION

One embodiment of the present disclosure provides an electrode of a fuel cell and a fuel cell including the same. Specifically, a fuel cell electrode and a fuel cell including the same are provided, which may protect the electrode from a Cr gas by forming an oxide film on the surface of the substrate.

An electrode of a fuel cell according to an embodiment of the present disclosure includes a substrate and an oxide film formed on one or both surfaces of the substrate, wherein the oxide film includes a spinel including at least one of Co, Ni, Cu, Mn, Fe, and Cr.

The spinel may include at least one of Co and Ni.

The spinel may include at least one of Co and Ni, and Cr.

The thickness of the oxide film may be 10 to 50 μm.

A porosity of the oxide film may be 10 to 50%.

A fuel cell according to an embodiment of the present disclosure includes a fuel electrode, an electrolyte layer positioned on the fuel electrode, and an cathode positioned on the electrolyte layer, wherein the cathode includes a substrate and an oxide film located on one or both sides of the substrate, and the oxide film including a spinel including at least one of Co, Ni, Cu, Mn, Fe, and Cr.

The spinel may include at least one of Co and Ni.

The spinel may include at least one of Co and Ni, and Cr.

The thickness of the oxide film may be 10 to 50 μm.

A porosity of the oxide film may be 10 to 50%.

The oxide film may be located on the upper surface of the substrate.

According to one embodiment of the present disclosure, Cr gas is consumed externally through the oxide film and prevented from reaching the electrode.

The oxide film that reacts with Cr may have an excellent electrical conductivity and act as a current collecting layer between the cell and the separator.

The oxide film does not lose the electrical conductivity after reacting with Cr, and there is no performance degradation due to the absorption of Cr.

### BRIEF DESCRIPTION OF THE DRAWINGS

FIG. 1 is a schematic diagram showing a cross-section of a fuel cell according to one embodiment of the present disclosure.

FIG. 2 is a scanning electron microscope (SEM) photograph of a cross-section of an cathode and an electrolyte layer manufactured in Example 2.

FIG. 3 is a view showing a result of X-ray diffraction analysis (XRD) of an oxide film manufactured in Example 1.

FIG. 4 is a transmission electron microscope (TEM) photograph of a oxide film manufactured in Example 1 after an exposure to a Cr vapor.

FIG. 5 is a graph showing a result of an electrical conductivity measurements before and after a Cr exposure for an electrode manufactured in Example 1.

FIG. 6 is a view showing a result of measuring an impedance after a Cr exposure for an electrode manufactured in Example 1.

FIG. 7 is a view showing a result of measuring an impedance after a Cr exposure for an electrode manufactured in Comparative Example 1.

FIG. 8 is a scanning electron microscope (SEM) photograph after a Cr exposure stability evaluation of an electrode manufactured in Example 1.

FIG. 9 is a scanning electron microscope (SEM) photograph after a Cr exposure stability evaluation for an electrode manufactured in Comparative Example 1.

FIG. 10 is a view showing a results of manufacturing a full cell in Example 2 and evaluating a long-term stability.

FIG. 11 is a scanning electron microscope (SEM) photograph of an electrode after manufacturing a full cell in Example 2 and evaluating a long-term stability.

FIG. 12 is a scanning electron microscope (SEM) photograph of an electrode after manufacturing a full cell in Comparative Example 2 and evaluating a long-term stability.

### DETAILED DESCRIPTION OF THE EMBODIMENTS

The technical terms used in the present disclosure are only for describing a particular exemplary embodiment, but it is considered that the present disclosure is not limited thereto. The singular forms used in the present disclosure include plural forms as long as the phrases do not clearly have a contrary sense. The meaning of “including” used in the specification specifies a specific characteristic, area, integer, step, action, element, and/or component, but it is not considered to eliminate the existence or addition of other characteristics, areas, integers, steps, actions, elements, and/or components.

Unless otherwise defined, all terms including technical terms and scientific terms have the same meanings as those generally understood by a person skilled in the art of the present disclosure. The terms that are defined in a dictionary and are generally used are not to be interpreted with idealized meanings or overly formal meanings unless the terms are further interpreted and defined to have meanings corresponding to the related technique documents and the content disclosed herein.

Terms such as first, second, and third are used for explaining various parts, components, areas, layers, and/or sections, but the present disclosure is not limited thereto. These terms are used only for distinguishing any part, component, area, layer, or section from other parts, components, areas, layers, or sections. Therefore, a first part, component, area, layer, or section to be described below may be referred to as second part, component, area, layer, or section within the range of the present disclosure.

In the present specification, the term “combination of these” included in the expression of a Markush form means one or more mixtures or combinations selected from a group consisting of configuration components described in the Markush form representation, and it means to include one or more selected from the group consisting of the configuration components.

Hereinafter, an embodiment of the present disclosure will be described in detail. However, this is provided as an example and the present disclosure is not limited thereby, and the present disclosure is defined only by a scope of claims described below.

According to one embodiment of the present disclosure, an electrode 30 of a fuel cell 100 has a substrate 31 and an oxide film 32 on one or both surfaces of the substrate 31, and the oxide film 32 includes a spinel including at least one of Co and Ni.

According to one embodiment of the present disclosure, when the spinel in the oxide film 32 is exposed to a Cr vapor at a high temperature, it reacts with Cr, and the spinel reacted with Cr rather increases in an electrical conductivity, so that the oxide film may function as a current collector and protect the electrode 30 from a Cr gas flowing in from the outside.

The fuel cell 100 may be a solid oxide fuel cell (SOFC) and a high temperature water electrolysis cell (SOEF).

The electrode 30 may be an cathode, and the substrate 31 of the electrode 30 is not particularly limited, but may specifically include lanthanum strontium cobalt oxide (LSC).

The oxide film 32 includes the spinel including at least one of Co, Ni, Cu, Mn, Fe, and Cr. More specifically, it may include the spinel including Co and Ni.

These spinel react with Cr at high temperatures, absorb Cr, and even if the spinel such as Co—Cr, Ni—Cr, and Co—Ni—Cr are formed, the electrical conductivity actually increases, and the electrode 30 may be protected from Cr gas flowing in from the outside.

The spinel may include one or more of Co and Ni. These elements are advantageous in terms of a reactivity with Cr, so they may protect the electrode 30 from Cr gas.

More specifically, it may include at least one of Co and Cr and Cr. At this time, Cr may be that the Cr gas that has volatilized during the fuel cell use process is absorbed. Cr may be included in an amount of 5 to 50 at % within the entire spinel.

The spinel may be represented by Chemical Formula 1 following.

(M¹ₓM²₁₋ₓ)₃O₄ [Chemical Formula 1]

(In Chemical Formula 1, M1 and M2 represent at least one of Co, Ni, Cu, Mn, Fe, and Cr, M1 and M2 are different from each other, and x is 0.1 to 1.)

The thickness of the oxide film 32 may be 10 to 50 μm. If the thickness of the oxide film 32 is too thin, it may be difficult to sufficiently protect the electrode 30 from the Cr gas by the oxide film 32. If the thickness of the oxide film 32 is too thick, it may impede the movement of an oxygen gas and reduce the performance. More specifically, the thickness of the oxide film 32 may be 15 to 30 μm.

The porosity of the oxide film 32 may be 10 to 50%. If the porosity is too low, the movement of the oxygen gas may be impeded, which may reduce the performance of the battery. If the porosity is too large, the proportion of the spinel may be too small, making it difficult to sufficiently protect the electrode 30 from the Cr gas. More specifically, the porosity of the oxide film 32 may be 20 to 40%. The porosity may be measured by an electron microscope image analysis.

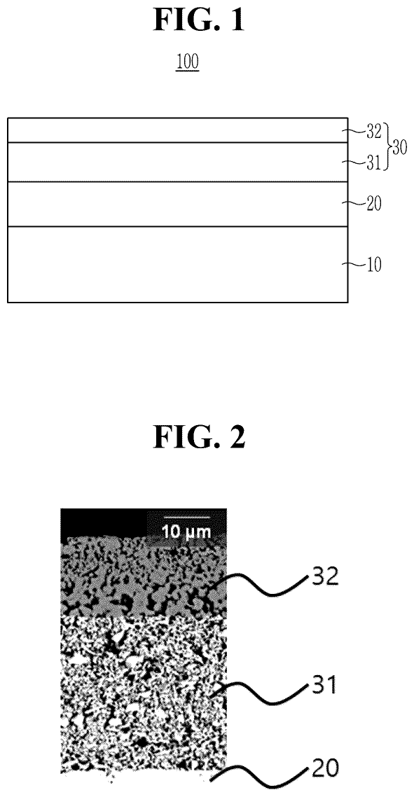

FIG. 1 schematically illustrates the fuel cell 100 according to one embodiment of the present disclosure.

As shown in FIG. 1, the fuel cell 100 according to one embodiment of the present disclosure includes a fuel electrode 10, an electrolyte layer 20 positioned on the fuel electrode 10, and an cathode 30 positioned on the electrolyte layer 20. The cathode 30 includes a substrate 31 and a oxide film 32 located on one or both sides of the substrate 31, and the oxide film 32 includes a spinel including at least one of Co, Ni, Cu, Mn, Fe, and Cr.

According to one embodiment of the present disclosure, when spinel in the oxide film 32 is exposed to Cr vapor at a high temperature, it reacts with Cr, and the spinel reacted with Cr rather increases in electrical conductivity, so that the oxide film functions as a current collector and can protect the cathode 30 from Cr gas flowing in from the outside.

The fuel cell 100 may be a solid oxide fuel cell (SOFC) and a high temperature water electrolysis cell (SOEF).

The substrate 31 of the cathode 30 is not particularly limited, but may specifically include a lanthanum strontium cobalt oxide (LSC).

The oxide film 32 includes the spinel including at least one of Co, Ni, Cu, Mn, Fe, and Cr. More specifically, it may include the spinel including Co and Ni.

The spinel reacts with Cr at high temperatures, absorb Cr, and even if the spinel such as Co—Cr, Ni—Cr, and Co—Ni—Cr are formed, the electrical conductivity actually increases, and the cathode 30 may be protected from a Cr gas flowing in from the outside.

The spinel may include one or more of Co and Ni. These elements are advantageous in terms of the surface area, so they may protect the cathode 30 from the Cr gas.

More specifically, it may include at least one of Co and Cr, and Cr. At this time, Cr may be that the Cr gas that has volatilized during the fuel cell use process is absorbed. Cr may be contained in an amount of 5 to 50 at % within the entire spinel.

The spinel may be represented by Chemical Formula 1 following.

(M¹ₓM²₁₋ₓ)₃O₄ [Chemical Formula 1]

(In Chemical Formula 1, M1 and M2 represent at least one of Co, Ni, Cu, Mn, Fe, and Cr, M1 and M2 are different from each other, and x is 0.1 to 1.)

The thickness of the oxide film 32 may be 10 to 50 μm. If the thickness of the oxide film 32 is too thin, it may be difficult to sufficiently protect the electrode 30 from the Cr gas by the oxide film 32. If the thickness of the oxide film 32 is too thick, the movement of the oxygen gas may be impeded, which may lower performance. More specifically, the thickness of the oxide film 32 may be 15 to 30 μm.

The porosity of the oxide film 32 may be 10 to 50%. If the porosity is too low, the movement of oxygen gas may be impeded, which may reduce the performance of the battery. If the porosity is too large, the proportion of spinel is too small, making it difficult to sufficiently protect the cathode 30 from Cr gas. More specifically, the porosity of the oxide film 32 may be 20 to 40%.

As shown in FIG. 1, the oxide layer 32 may be positioned on the upper surface of the substrate 31.

Additionally, the electrolyte layer 20 is located on the fuel electrode 10 and is not particularly limited, but may include gadolinium-doped ceria (GDC) and yttria-stabilized zirconia (YSZ).

The fuel electrode 10 may include zirconia (Ni-YSZ) in which nickel and yttria are stabilized.

There is no particular limitation on the method for forming the oxide film 32, and it may be manufactured by preparing a paste including a spinel powder, applying the paste on the substrate, and sintering it.

Hereinafter, embodiments of the present disclosure will be described in detail. However, this is provided as an example and the present disclosure is not limited thereby, and the present disclosure is defined only by the scope of the claims described below.

### EXAMPLE 1: FABRICATION OF AN ELECTRODE INCLUDING AN OXIDE FILM (WITH Co—Ni LAYER)

Co—Ni spinel was manufactured by a glycine-nitrate process and mixed with a solvent to produce a paste. This paste was deposited by a screen printing on a lanthanum strontium cobalt oxide (LSC) substrate and sintered at 950° C. to form the oxide film with the thickness of approximately 20 μm.

### COMPARATIVE EXAMPLE 1: ELECTRODE WITHOUT AN OXIDE FILM (NO Co—Ni Layer)

An electrode was fabricated using a lanthanum strontium cobalt oxide (LSC) substrate without an oxide film.

### EXPERIMENTAL EXAMPLE 1: X-RAY DIFFRACTION (XRD) AND TRANSMISSION ELECTRON MICROSCOPY (TEM) ANALYSES

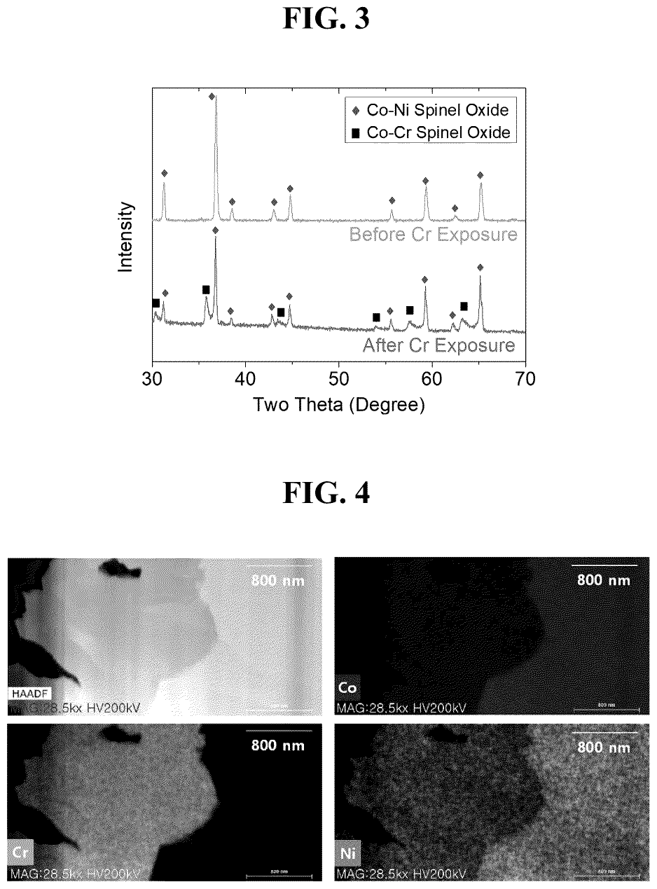

An X-ray diffraction analysis (XRD) was performed on the electrode manufactured in Example 1, and after the electrode manufactured in Example 1 was exposed to a Cr vapor at a temperature of 800° C. for 100 hours, an X-ray diffraction analysis (XRD) and a transmission electron microscopy (TEM) analysis were performed, and the results are shown in FIG. 3 and FIG. 4.

As shown in FIG. 3, before the Cr exposure, the spinel structure was observed after the synthesis of a Co—Ni oxide, and after the Cr exposure, it was confirmed that a Co—Cr spinel was formed by reacting with Cr after the exposure.

In addition, it may be confirmed in FIG. 4 that the Co—Cr spinel was formed on the surface when being exposed to the Cr vapor.

As shown in FIG. 3 and FIG. 4, it may be confirmed that after the exposure to the Cr vapor, 15 at % of Cr was included within the oxide film.

### EXPERIMENTAL EXAMPLE 2: ELECTRICAL CONDUCTIVITY MEASUREMENT

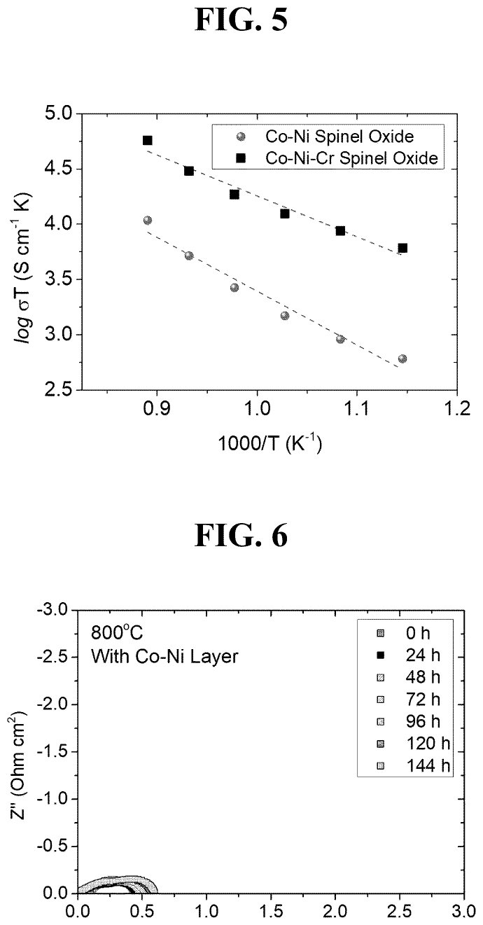

The electrical conductivity of the electrode manufactured in Example 1 before (Co—Ni Spinel Oxide) and after (Co—Ni—Cr Spinel Oxide) exposure to the Cr was measured and shown in FIG. 5.

As shown in FIG. 5, it may be confirmed that the electrical conductivity level usable as a current collector in SOFC and SOEC was obtained.

Additionally, it may be confirmed that when Co-Ni spinel reacts with Cr to form the spinel including Cr, the electrical conductivity actually increases. Ultimately, it may be confirmed that the performance of the Co—Ni spinel current collector was not deteriorated but rather improved through the reaction with Cr.

### EXPERIMENTAL EXAMPLE 3: HALF-CELL FABRICATION, IMPEDANCE MEASUREMENT, AND SEM OBSERVATION

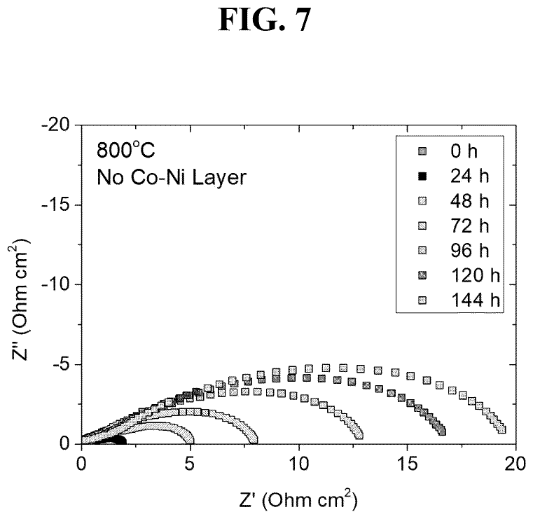

The electrodes manufactured in Example 1 and Comparative Example 1 were exposed to Cr at 700° C. for 24 hours, and the increase in the impedance was measured, which is shown in FIG. 6 and FIG. 7, respectively.

In the case of Example 1, it may be confirmed that a polarization resistance was maintained within 1 Ohm cm2 when being measured for the same period of time.

On the other hand, in the case of Comparative Example 1, it may be confirmed that the polarization resistance increased to approximately 20 Ohm cm2 over 144 hours due to a Cr poisoning.

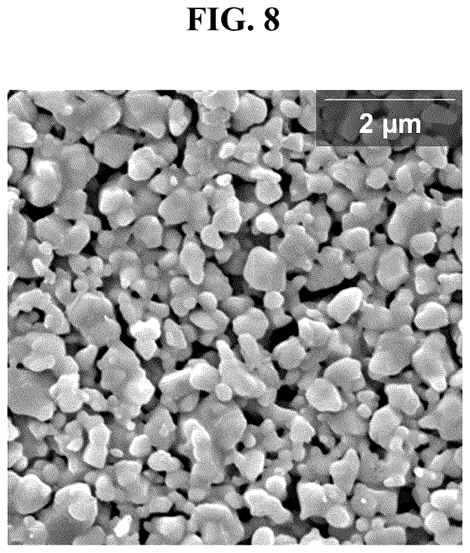

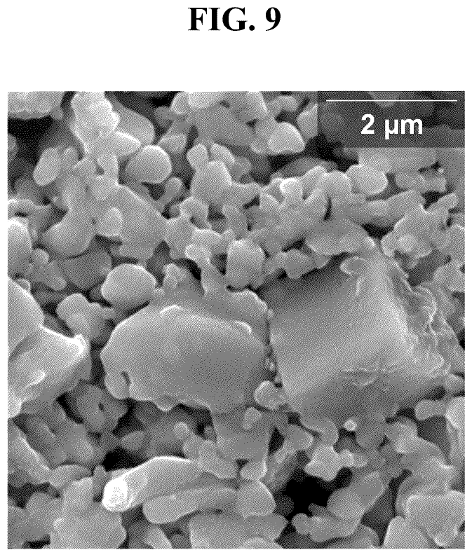

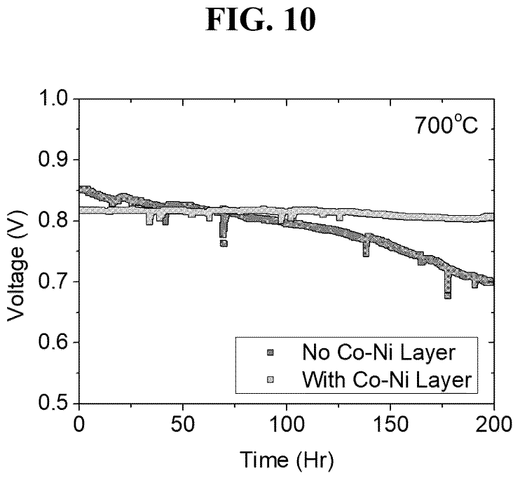

Additionally, after the Cr exposure, the surface of the oxide film was observed using a scanning electron microscope (SEM), and the photographs are shown in FIG. 8 and FIG. 9.

In the case of Example 1, it may be confirmed that a dense porous structure was maintained without a generation of reactants even after the long-term exposure to Cr. At this time, the porosity was confirmed to be ~25%.

In the case of Comparative Example 1, it may be confirmed that a large amount of reactant with Cr was produced.

### EXAMPLE 2 AND COMPARATIVE EXAMPLE 2: PREPARATION OF FULL CELL

A full cell was manufactured using a fuel electrode as Ni-YSZ, a electrolyte layer as YSZ-GDC, and the cathode of Example 1. This is named as Example 2. Additionally, the full cell was manufactured using the cathode of Comparative Example 1 instead of the cathode of Example 1. This is named as Comparative Example 2.

FIG. 2 shows a scanning electron microscope (SEM) photograph of a cross-section of the cathode and electrolyte layer manufactured in Example 2.

### EXPERIMENTAL EXAMPLE 4: LONG-TERM STABILITY EVALUATION

The long-term stability at 700° C. was evaluated in an environment exposed to a large amount of Cr by using the full cells manufactured in Example 2 (with a Co—Ni layer) and Comparative Example 2 (a No Co—Ni layer).

When the long-term evaluation was conducted under a constant current condition of 0.5A/cm2 , it may be confirmed that Example 2 had a slightly lower initial performance but operated stably and experienced almost no voltage drop. On the other hand, in Comparative Example 2, it may be confirmed that the cell voltage decreased at a rapid rate and a performance deterioration occured.

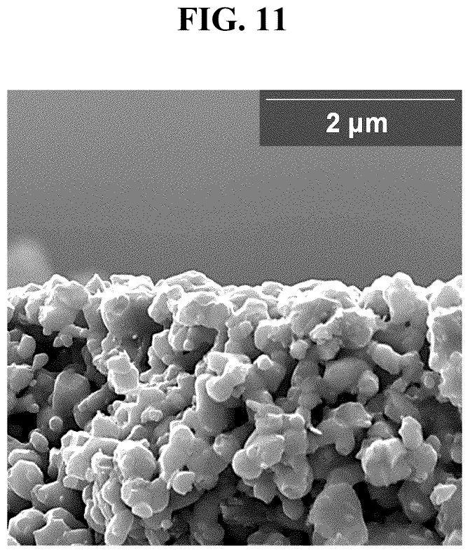

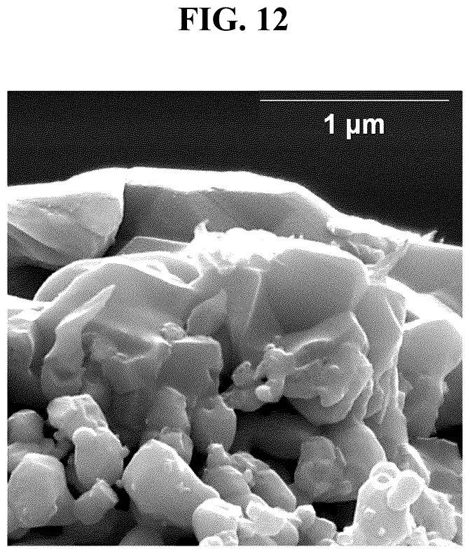

Additionally, after the long-term evaluation, the cross-section of the cell was observed using a scanning electron microscope (SEM), and photographs are shown in FIG. 11 and FIG. 12.

In the case of Example 2, it may be confirmed that the reaction with Cr was effectively suppressed by maintaining an dense electrode structure of a porous.

On the other hand, as shown in the case of Comparative Example 2, a secondary phase with the dense structure was observed, which was generated through the reaction with Cr on the surface.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: fuel cell, 10: fuel electrode,
20: electrolyte layer, 30: cathode, electrode
31: substrate, 32: oxide film

What is claimed is:

1. An electrode of a fuel cell comprising:
a substrate and an oxide film formed on one or both surfaces of the substrate,
wherein the oxide film includes a spinel including at least one of Co, Ni, Cu, Mn, Fe, and Cr.

2. The electrode of the fuel cell of claim 1, wherein:
the spinel includes at least one of Co and Ni.

3. The electrode of the fuel cell of claim 2, wherein:
the spinel includes at least one of Co and Ni, and Cr.

4. The electrode of the fuel cell of claim 1, wherein:
the thickness of the oxide film is 10 to 50 μm.

5. The electrode of the fuel cell of claim 1, wherein:
a porosity of the oxide film is 10 to 50%.

6. A fuel cell comprising
a fuel electrode, an electrolyte layer positioned on the fuel electrode, and an cathode positioned on the electrolyte layer,
wherein the cathode includes a substrate and an oxide film located on one or both sides of the substrate, and
the oxide film including a spinel including at least one of Co, Ni, Cu, Mn, Fe, and Cr.

7. The fuel cell of claim 6, wherein:
the spinel includes at least one of Co and Ni.

8. The fuel cell of claim 7, wherein:
the spinel includes at least one of Co and Ni, and Cr.

9. The fuel cell of claim 6, wherein:
the thickness of the oxide film is 10 to 50 μm.

10. The fuel cell of claim 6, wherein:
a porosity of the oxide film is 10 to 50%.

11. The fuel cell of claim 6, wherein:
the oxide film is located on the upper surface of the substrate.
